(19) United States
(12) Patent Application Publication
(10) Pub. No.: US 2025/0350199 A1
(43) Pub. Date: Nov. 13, 2025

(54) POWER CONVERTER AND ELECTRONIC DEVICE INCLUDING SAME

(71) Applicant: Samsung Electronics Co., Ltd., Suwon-si (KR)

(72) Inventor: Hangseok CHOI, Suwon-si (KR)

(21) Appl. No.: 19/081,825

(22) Filed: Mar. 17, 2025

Related U.S. Application Data
(63) Continuation of application No. PCT/KR2025/002065, filed on Feb. 12, 2025.

(30) Foreign Application Priority Data
May 9, 2024 (KR) 10-2024-0061470
Jun. 27, 2024 (KR) 10-2024-0084699

(51) Int. Cl. H02M 3/00; H02M 1/00; H02M 3/158

(52) U.S. Cl. CPC H02M 3/01; H02M 1/0058; H02M 3/158

(57) ABSTRACT

A power converter and an electronic device including the same are disclosed. The power converter includes a switching circuit comprising a first switch and a second switch connected in series between a power source and the ground, a resonant circuit connected to the switching circuit through a first node between the first switch and the second switch and comprising a resonant capacitor, a first inductor, and a second inductor, and a third switch connecting or disconnecting between a second node of the resonant circuit and a load. The operation mode of the power converter includes a first mode, a second mode, and a third mode in which the switching states of the first switch, the second switch, and the third switch are controlled differently from each other.

### CROSS-REFERENCE TO RELATED APPLICATIONS

This application is a continuation of International Application No. PCT/KR2025/002065 designating the United States, filed on Feb. 12, 2025, in the Korean Intellectual Property Receiving Office and claiming priority to Korean Patent Application Nos. 10-2024-0061470, filed on May 9, 2024, and 10-2024-0084699, filed on Jun. 27, 2024, in the Korean Intellectual Property Office, the disclosures of each of which are incorporated by reference herein in their entireties.

### BACKGROUND

### Field

The disclosure relates to a power converter and an electronic device including the same, and for example, to a resonant power converter for soft switching and an electronic device including the same.

### Description of Related Art

A power converter (or switching regulator) can include a circuit for converting a direct current input voltage into a desired direct current output voltage. The type of power converter includes a buck converter for step-down, a boost converter for step-up, a buck-boost converter of performing step-up and step-down, or an inverting buck-boost converter of performing all of step-up and step-down and presenting a negative voltage (inverted voltage).

In general, compared to the buck converter or the boost converter, a high-power converter, for example, a power converter that uses a high voltage or inverted voltage, such as an inverting buck-boost converter, can be relatively large in inductor current, and can also be relatively large in voltage stress applied to each switch.

### SUMMARY

A power converter according to an example embodiment includes a power converter configured to convert an input voltage from a power source into a negative output voltage, and may include: a switching circuit, a resonant circuit, and a third switch. The switching circuit may be connected in series between the power source and ground, and may include: a first switch and a second switch configured to be alternately turned on. The resonant circuit may be connected to the switching circuit through a first node between the first switch and the second switch. The resonant circuit may include a resonant capacitor, a first inductor, and a second inductor connected in series with each other. The third switch may be connected to the resonant circuit through a second node between the first inductor and the second inductor. The third switch may be configured to connect or disconnect between the resonant circuit and a load. An operating mode of the power converter may include a first mode, a second mode, and a third mode. The first mode may include a mode of turning on the first switch connected to the power source, and turning off the third switch. The second mode may include a mode of turning on the second switch connected to the ground, and turning on the third switch. The third mode may include a mode of turning on the second switch connected to the ground, and turning off the third switch.

An electronic device according to an example embodiment may include: an organic light emitting display, a display driver IC (DDI) configured to drive the organic light emitting display, and a display power management IC (PMIC) including a power converter configured to convert an input voltage from a power source into a negative output voltage, and configured to provide a driving voltage required to drive the display driver IC using the power converter. The power converter may include: a switching circuit, a resonant circuit, and a third switch. The switching circuit may be connected in series between the power source and ground, and may include a first switch and a second switch configured to be alternately turned on. The resonant circuit may be connected to the switching circuit through a first node between the first switch and the second switch. The resonant circuit may include a resonant capacitor, a first inductor, and a second inductor connected in series with each other. The third switch may be connected to the resonant circuit through a second node between the first inductor and the second inductor. The third switch may be configured to connect or disconnect between the resonant circuit and a load. An operating mode of the power converter may include a first mode, a second mode, and a third mode. The first mode may include a mode of turning on the first switch connected to the power source, and turning off the third switch. The second mode may include a mode of turning on the second switch connected to the ground, and turning on the third switch. The third mode may include a mode of turning on the second switch connected to the ground, and turning off the third switch.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A, 1B and 1C are graphs illustrating a soft switching effect of a power converter according to various embodiments;

FIG. 2 is a circuit diagram illustrating an example configuration of a power converter according to various embodiments;

FIG. 3 is a waveform diagram illustrating a soft switching operation of a power converter according to various embodiments;

FIGS. 4A, 4B, and 4C are circuit diagrams illustrating example mode-specific operations of a power converter according to various embodiments;

FIG. 5 is a waveform diagram illustrating example mode-specific operations of a power converter according to various embodiments;

FIGS. 6, 7, and 8 are circuit diagrams illustrating examples of modifications of a power converter according to various embodiments;

FIG. 9 is a block diagram illustrating an example configuration of an electronic device including a power converter according to various embodiments; and

FIG. 10 is a block diagram illustrating an example electronic device in a network environment according to various embodiments.

### DETAILED DESCRIPTION

Various example embodiments of the disclosure will be described below in greater detail with reference to the drawings. However, the disclosure may be implemented in various different forms and is not limited to the various embodiments described herein. In relation with the description of the drawings, the same or similar reference numerals may be used for the same or similar components. In addition, in the drawings and related descriptions, descriptions of well-known functions and constructions may be omitted for clarity and conciseness.

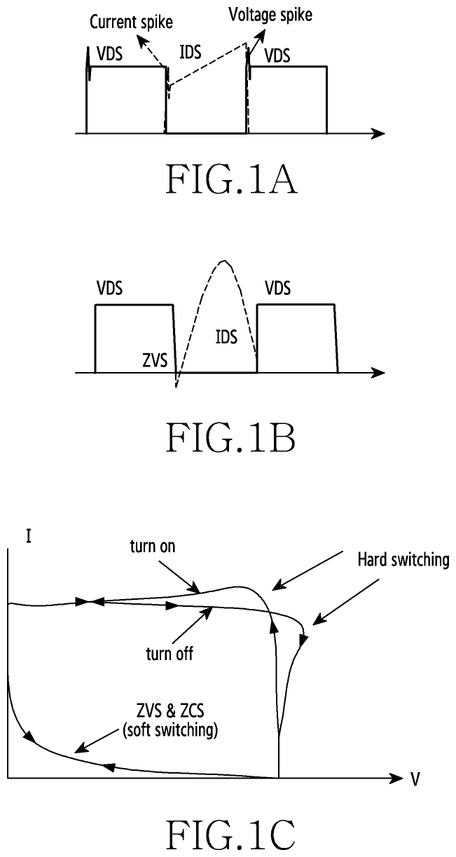

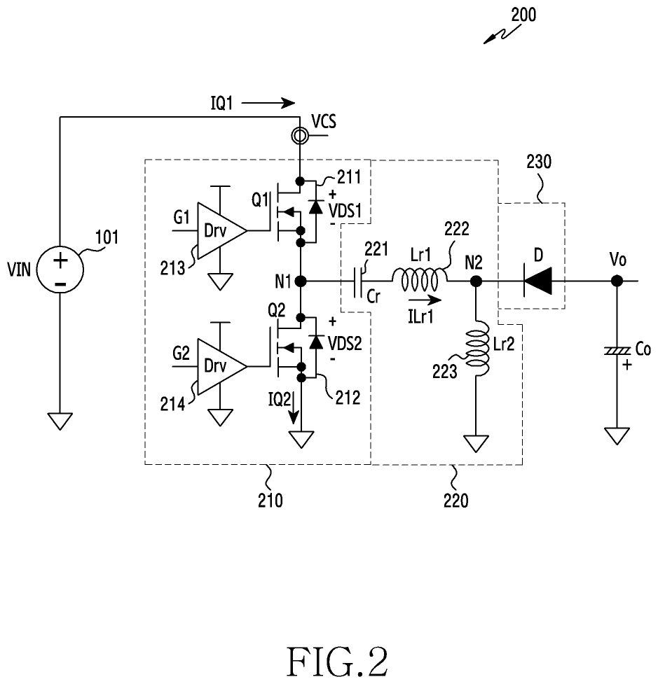

FIGS. 1A, 1B and 1C are graphs illustrating a soft switching effect of a power converter (e.g., power converter 200 of FIG. 2) according to various embodiments.

FIG. 1A is a graph illustrating a switch waveform (switch voltage VDS and switch current IDS) of a hard switching power converter according to a comparative example. FIG. 1B is a graph illustrating a switch waveform (switch voltage VDS and switch current IDS) of a soft switching power converter according to an embodiment. Soft switching may refer, for example, to zero voltage switching (ZVS) and/or zero current switching (ZCS). FIG. 1C is a graph illustrating a comparison of switch waveforms (switch voltage-current change at turn-on/turn-off) of the hard switching power converter according to a comparative example and the soft switching power converter according to various embodiments.

As illustrated in FIGS. 1A and 1C, in the hard switching power converter, the switch current IDS appears in a square wave form. In this case, when a switch is turned on/off, the switch current IDS may rapidly increase or decrease, and may induce a heavy switching noise or a high-frequency electro magnetic interference (EMI). For example, when a voltage and a current overlap at the moment (or switching transition time) the switch is turned on/off, a voltage spike or current spike may occur, and this may result in an increase of a switching loss.

In addition, in a power converter used in an electronic device requiring a negative output voltage, a voltage difference between an input voltage and an output voltage may become relatively large, and a voltage stress applied to each switch and a resultant voltage stress may increase as well.

Referring to FIGS. 1B and 1C, in the soft switching power converter of an embodiment, the switch current IDS may have a sinusoidal shape, and this may result in a decrease of a switching noise and an EMI. In addition, since the switch current IDS has a constant slope of the sinusoidal shape during the switching transition time, a duration where a voltage and a current overlap may decrease, and thus a switching loss may decrease. Accordingly, a power conversion efficiency may be improved.

FIG. 2 is a circuit diagram illustrating an example configuration of a power converter 200 according to various embodiments.

According to an embodiment, the power converter 200 is a resonant inverting buck-boost converter for soft switching, and may step up, step down, or invert an input voltage to a desired output voltage.

Referring to FIG. 2, the power converter 200 may include a switching circuit 210, a resonant circuit 220, and a third switch 230.

According to an embodiment, the power converter 200 may include a first switch 211 (e.g., first MOSFET) arranged between a power source 101 and a first node N1, a second switch 212 (e.g., second MOSFET) arranged between the first node N1 and the ground, a resonant capacitor 221 connected to the first node N1 between the first switch 211 and the second switch 212, a first inductor 222 connected in series with the resonant capacitor 221, a second inductor 223 connected in series with the first inductor 222, and the third switch 230 (e.g., diode) connected to the second node N2 between the first inductor 222 and the second inductor 223. According to an embodiment, the first switch 211 and the second switch 212 may be input switches (or power switches) arranged at the input side of the power converter 200. The third switch 230 may be an output switch arranged at an output side (or load side) of the power converter 200.

According to an embodiment, the power converter 200 may convert the input voltage from the power source 101 (or input node VCS) into a negative output voltage by a switching operation of the switching circuit 210 and a resonance operation of the resonant circuit 220, and supply the converted negative output voltage to an output node Vo (or load). The input voltage and the negative output voltage may be direct current voltages of different levels. The input voltage may include a positive voltage (direct current voltage having a positive value) having an electric potential higher than the ground, and the negative output voltage may be a negative voltage (direct current voltage having a positive value) having an electric potential lower than the ground.

According to an embodiment, the switching circuit 210 may include the first switch 211 and the second switch 212 connected in series between the power source 101 and the ground (GND). The first switch 211 and the second switch 212 may be turned on alternately. For example, during one half cycle of a switching cycle, the first switch 211 may be turned on and the second switch 212 may be turned off. During the other half cycle of the switching cycle, the first switch 211 may be turned off and the second switch 212 may be turned on.

According to an embodiment, the switching circuit 210 may further include a first driver 213 driving the first switch 211, and a second driver 214 driving the second switch 212.

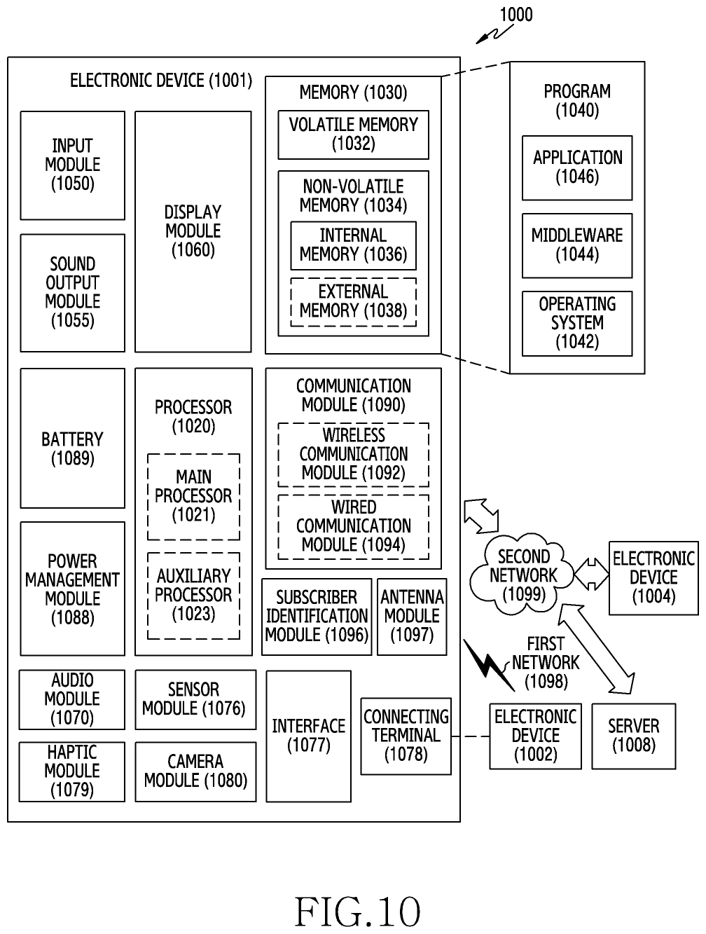

According to an embodiment, the first switch 211 and the second switch 212 are for switching operation, and may be arranged between the power source 101 (e.g., battery 1089 or alternating current adapter of FIG. 10) supplying the input voltage, and the ground. The first switch 211 may be arranged between the power source 101 (or input node VCS) and the first node N1. The second switch 212 may be arranged between the first node N1 and the ground.

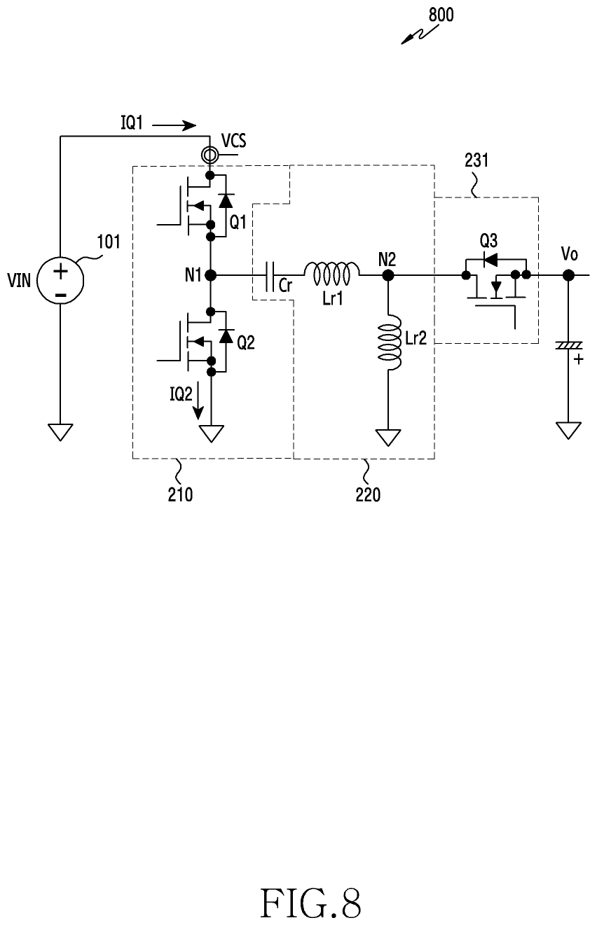

According to an embodiment, the first switch 211 and the second switch 212 may each include a metal oxide semiconductor field effect transistor (MOSFET). According to an embodiment, the third switch 230 may include a rectifier diode as illustrated, but is not limited thereto. For example, the third switch 230 may also include a MOSFET (e.g., MOSFET 231 of FIG. 8).

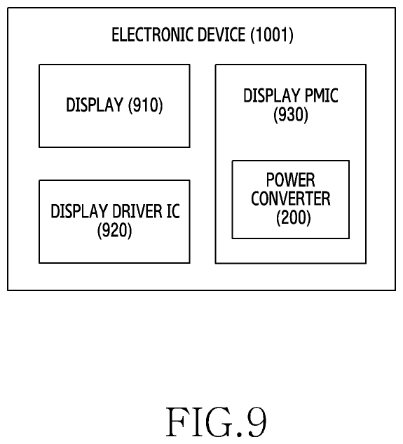

According to an embodiment, the first driver 213 may be connected to a gate of the first switch 211. The first driver 213 is a power amplifier, and may receive a low-power input signal of a relatively low level from a processor (e.g., display driver IC 920 of FIG. 9 or processor 1020 of FIG. 10) and then, provide a first switching signal required for turning on and turning off the first switch 211 by amplification. The second driver 214 is a power amplifier, and may receive a low-power input signal of a relatively low level from the processor (e.g., display driver IC 920 of FIG. 9 or processor 1020 of FIG. 10) and then, provide a second switching signal required for turning on and turning off the second switch 212 by amplification.

In an embodiment, the switching circuit 210 may alternately turn on the first switch 211 and the second switch 212 and selectively connect the resonant circuit 220 to one of the first switch 211 and the second switch 212.

According to an embodiment, the resonant circuit 220 may be connected to the switching circuit 210 via the first node N1. The first node N1 may be a node between the first switch 211 and the second switch 212 that are connected in series with each other. The resonant circuit 220 may be connected to the third switch 230 via the second node N2. The second node N2 may be a node between the first inductor 222 and the second inductor 223 that are connected in series with each other. The resonant circuit 220 may include three resonant elements such as the resonant capacitor 221, the first inductor 222, and the second inductor 223. The three resonant elements may be connected in series with each other. The resonant capacitor 221 may be connected to an input side of the power converter 200 through the switching circuit 210. One side of the resonant capacitor 221 may be connected to the first node N1 between the first switch 211 and the second switch 212. The other side of the resonant capacitor 221 may be connected to the first inductor 222 and the second inductor 223 that are connected in series with each other. The second inductor 223 may be connected to the output side of the power converter 200 through the third switch 230.

According to an embodiment, the third switch 230 may connect or disconnect between the second node N2 of the resonant circuit 220 and the output node Vo (or load). The third switch 230 may be connected to the resonant circuit 220 through the second node N2 between the first inductor 222 and the second inductor 223.

According to an embodiment, an operation mode of the power converter 200 may include a first mode, a second mode, and a third mode.

According to an embodiment, the power converter 200 may operate in one of a plurality of operation modes, for example, the first mode, the second mode, and the third mode, depending on switching states (or on/off states) of the first switch 211, the second switch 212, and the third switch 230.

According to an embodiment, the first mode may be a mode in which the first switch 211 connected to the power source 101 among the first switch 211 and the second switch 212 is turned on and the third switch 230 is turned off. The second mode may be a mode in which the second switch 212 connected to the ground among the first switch 211 and the second switch 212 is turned on and the third switch 230 is turned on. The third mode may be a mode in which the second switch 212 connected to the ground among the first switch 211 and the second switch 212 is turned on and the third switch 230 is turned off.

According to an embodiment, the first mode may be a mode for storing energy through the resonant circuit 220. The second mode may be a mode for supplying the energy stored in the resonant circuit 220 to the load. The third mode may be a mode for supporting soft switching of at least one of the first switch 211, the second switch 212, and the third switch 230.

According to an embodiment, the resonant circuit 220 may perform a multi-resonance operation using one resonant capacitor 221 and two inductors 222 and 223 connected in series with each other. The resonant circuit 220 may have a multi-resonance frequency depending on the operation mode of the power converter 200.

According to an embodiment, the switching circuit 210 may provide a switching pulse voltage in the form of a square wave. The switching pulse voltage may be applied to the resonant circuit 220 through the first node N1. In the power converter 200, two switches 211 and 212 of the switching circuit 210 may be connected in series between the power source 101 and the ground and may be alternately switched. By the switching, a node voltage of the first node N1 corresponding to a lower voltage of the first switch 211 or a higher voltage of the second switch 212 may be formed in the form of a switching pulse voltage (or form of a square wave) that switches between the input voltage from the power source 101 and the ground voltage. The switching pulse voltage may be applied to the resonant circuit 220 including one resonant capacitor 221 and two inductors 222 and 223 and form a resonant inductor current in the form of a sinusoidal wave (e.g., sine wave or pseudo-sine wave). The resonant inductor current flowing in the resonant circuit 220 may be periodically changed according to a switching frequency of the switching circuit 210. The switching frequency of the switching circuit 210 may correspond to a switching frequency of the switching pulse voltage applied to the first node N1. The resonant circuit 220 may repeatedly store and release electromagnetic energy using energy storage elements that are the capacitor 221, the first inductor 222, and the second inductor 223, according to a change of the resonant inductor current flowing in the first inductor 222 and/or the second inductor 223 and a charging/discharging operation of the resonant capacitor 221 linked to the change of the resonant inductor current, and provide a certain level of output voltage.

According to an embodiment, the switching circuit 210 may implement soft switching (zero voltage switching and/or zero current switching) using a half-bridge type circuit that controls a node voltage of the first node N1 with two switches 211 and 212 connected in series with each other. For example, the zero voltage switching may refer, for example, to each switch 211 or 212 being turned on in a state in which a voltage across each switch 211 or 212 drops to zero voltage. The zero current switching may refer, for example, to each switch 211 or 212 being turned off in a state in which a current across each switch 211 or 212 drops to zero current (or negative current).

According to an embodiment, while the power converter 200 operates in the first mode, the power converter 200 may store energy in the resonant capacitor 221 through a first serial path within the resonant circuit 220. According to an embodiment, as the first switch 211 is turned on, the resonant circuit 220 may receive the input voltage through the first node N1, and store energy in the resonant capacitor 221 through the first serial path within the resonant circuit 220. For example, the first serial path may be a path including the resonant capacitor 221, the first inductor 222, and the second inductor 223.

According to an embodiment, while the power converter 200 operates in the second mode, the power converter 200 may supply energy stored in the resonant capacitor 221 to the load through a second serial path within the resonant circuit 220. According to an embodiment, as the second switch 212 is turned on, the resonant circuit 220 may transfer energy stored in the resonant capacitor 221 to the load through the second serial path within the resonant circuit 220 and the second node N2. For example, the second serial path may be a part of the first serial path including all of the resonant capacitor 221, the first inductor 222, and the second inductor 223, and may be a path selectively including only the resonant capacitor 221 and the first inductor 222.

According to an embodiment, while the power converter 200 operates in the third mode, the power converter 200 may reduce a voltage of the first node N1 to zero voltage by a current flowing in the first serial path within the resonant circuit 220 wherein the turned-off first switch 211 may satisfy a soft switching condition before being turned on.

According to an embodiment, the switching circuit 210 may provide a first switching signal for the first switch 211 and a second switching signal for the second switch 212 by a pulse frequency modulation (PFM) method or a pulse width modulation (PWM) method. The switching circuit 210 may regulate a negative output voltage to a certain level using the first switching signal and the second switching signal.

According to an embodiment, the switching circuit 210 may control (or set) a first switching frequency of the first switching signal for the first switch 211 and a second switching frequency of the second switching signal for the second switch 212 and regulate an output voltage to a certain level. In an embodiment, the first switching frequency and the second switching frequency may correspond to the switching frequency of the switching circuit 210, and have the same value.

According to an embodiment, the first switching signal and the second switching signal may be alternately applied with a predetermined delay time.

According to an embodiment, the switching circuit 210 may control (or set) the switching frequency of the first switching signal and the switching frequency of the second switching signal to have a higher value than a resonance frequency of the resonant circuit 220, and achieve soft switching of the first switch 211 and the second switch 212.

When the switching frequency of the switching circuit 210 is equal to or less than the resonance frequency of the resonant circuit 220, switching may occur before a voltage across each switch 211 or 212 drops to zero voltage in a turn-off state of each switch 211 or 212, and thus a zero-voltage switching effect may not appear or may be reduced. When the switching frequency of the switching circuit 210 is higher than the resonance frequency of the resonant circuit 220, the switching may occur after the voltage across each switch 211 or 212 drops to zero voltage in the turn-off state of each switch 211 or 212, and thus the zero-voltage switching effect may appear or be improved.

According to an embodiment, the switching circuit 210 may alternately apply the first switching signal for the first switch 211 and the second switching signal for the second switch 212, with a specified delay time, and enhance the zero-voltage switching effect. The delay time may correspond to a deadtime during which both the switches 211 and 212 are turned off.

According to an embodiment, the input voltage applied through the input node VCS may be a battery voltage. The switching circuit 210 may vary the switching frequency of the first switching signal and the switching frequency of the second switching signal, and regulate the negative output voltage supplied through the output node Vo, regardless of a battery charge state or a load state.

According to an embodiment, the switching circuit 210 may vary a duty ratio (or duty cycle) of the first switching signal and the second switching signal in a PWM method, and supply a constant level of output voltage desired by the load through the output node Vo.

For example, when the switching frequency of the switching circuit 210 is 1 MHz and the duty ratio is 50%, an output voltage of −6 V may be supplied. When the switching frequency is fixed to 1 MHz and the duty ratio is varied to 35%, an output voltage of −5 V may be supplied. When the switching frequency is fixed to 1 MHz and the duty ratio is varied to 20%, an output voltage of −4 V may be supplied.

For example, when a required output voltage temporarily changes or a battery charge rate decreases depending on a load state, the switching circuit 210 may adjust the level of the output voltage in a PWM method of varying the duty ratio.

According to an embodiment, the switching circuit 210 may control (or set) the switching frequency in a PFM method, and supply a constant level of output voltage desired by the load through the output node Vo.

For example, when the duty ratio of the switching circuit 210 is 50% and the switching frequency is 1 MHZ, an output voltage of −6 V may be supplied. When the duty ratio is fixed to 50% and the switching frequency is 1.05 MHz, an output voltage of −4.5 V may be supplied. When the duty ratio is fixed to 50% and the switching frequency is 1.1 MHZ, an output voltage of −3.5 V may be supplied.

For example, when a required output voltage temporarily changes or a battery charge rate decreases depending on a load state, the switching circuit 210 may adjust the level of the output voltage in a PFM method of varying the switching frequency.

According to an embodiment, the third switch 230 may be connected to the second node N2 of the resonant circuit 220, which is located between the first inductor 222 and the second inductor 223 connected in series with each other. The third switch 230 may be turned off, based on a difference between a first current flowing in the first inductor 222 and a second current flowing in the second inductor 223.

According to an embodiment, the third switch 230 may include a rectifier diode as illustrated in FIG. 2. When a forward bias is applied, the rectifier diode used as the third switch 230 may be turned on and connect the resonant circuit 220 to the load. When a reverse bias is applied, the rectifier diode may be turned off and disconnect between the resonant circuit 220 and the load.

According to an embodiment, the third switch 230 may include a MOSFET 231 as illustrated in FIG. 8. The MOSFET 231 used as the third switch 230 may be turned off in response to a third switching signal from the switching circuit 210. For example, the switching circuit 210 may monitor a current passing through the second node N2 while the second switch 212 is turned on. The current may correspond to an offset between a first current flowing in the first inductor 222 and a second current flowing in the second inductor 223. Only when the monitoring result shows that the offset has a positive value, the switching circuit 210 may apply a third switching signal of a high level, and control the MOSFET 231 to be turned on. When the monitoring result shows that the offset reaches a specified value (e.g., 0), the switching circuit 210 may not apply the third switching signal, or output a third switching signal of a low level, and control the MOSFET 231 to be turned off.

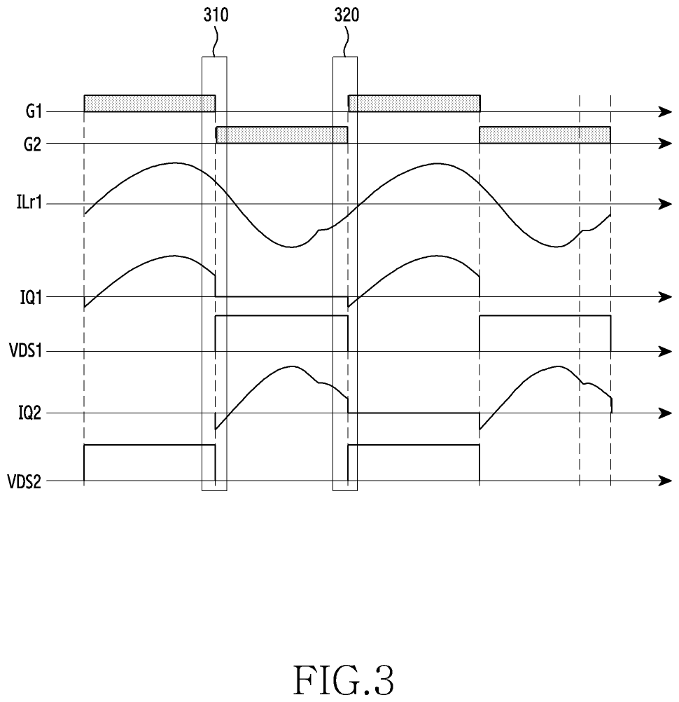

FIG. 3 is a waveform diagram illustrating a soft switching operation of the power converter 200 according to various embodiments.

Referring to FIG. 3, G1 is a waveform diagram of a first switching signal (or first gate driving signal) applied to a gate of the first switch 211. G2 is a waveform diagram of a second switching signal (or second gate driving signal) applied to a gate of the second switch 212. ILr1 is a current waveform diagram of the first inductor 222. IQ1 is a waveform diagram of a first switch current flowing in the first switch 211. VDS1 is a waveform diagram of a drain-source voltage of the first switch 211. IQ2 is a waveform diagram of a second switch current flowing in the second switch 212. VDS2 is a waveform diagram of a drain-source voltage of the second switch 212.

When the first switching signal G1 is high, the first switch 211 may be turned on, and when the first switching signal G1 is low, the first switch 211 may be turned off. Similarly, when the second switching signal G2 is high, the second switch 212 may be turned on, and when the first switching signal G2 is low, the second switch 212 may be turned off.

According to an embodiment, as illustrated in the waveform diagram of the first switch current IQ1 and the waveform diagram of the second switch current IQ2, a current flowing in the first switch 211 and the second switch 212 may have a sinusoidal wave shape (e.g., half-wave sine wave or pseudo-half-wave sine wave).

In FIG. 3, reference numeral 310 may be a first transition duration. Reference numeral 320 may be a second transition duration. The first transition duration 310 may indicate a moment when the second switch 212 is turned on. The second transition duration 320 may indicate a moment when the first switch 211 is turned on. Referring to the waveform diagram of the second switch current IQ2 and the first transition duration 310, it may be seen that the second switch 212 has a negative current value before being turned on. In addition, referring to the waveform diagram of the first switch current IQ1 and the second transition duration 320, the first switch 211 may also have a negative current value before being turned on. A negative current flowing in the second switch 212 during the first transition duration 310 and a negative current flowing in the first switch 211 during the second transition duration 320 discharge a junction capacitor of each switch 211 or 212, and decrease the drain-source voltage VDS1 or VDS2 of each switch 211 or 212 to zero voltage before turn-on.

In this way, since a voltage across each of the two switches 211 and 212 all drops to zero voltage before turn-on, zero voltage switching and/or zero current switching may be implemented.

In the power converter 200 of an embodiment, the principle of zero voltage switching and/or zero current switching using the two switches 211 and 212 connected in series with each other and the resonant circuit 220 is illustrated in greater detail as follows.

According to an embodiment, the first switching signal G1 (or first gate driving signal) for the first switch 211 and the second switching signal G2 (or second gate driving signal) for the second switch 212 may be alternately applied with a slight deadtime (or delay time) wherein the two signals do not overlap each other. The deadtime may be a duration in which all the switches 211 and 212 are turned off.

As illustrated in the first transition duration 310 of FIG. 3, in a state in which the first switch 211 is turned on and thus a positive current is flowing (see the IQ1 waveform diagram), and the drain-source voltage VDS2 of the second switch 212 is equal to the input voltage, the first switch 211 may be turned off when the switching circuit 210 changes the first gate driving signal of the first switch 211 from high to low. In this case, during the deadtime, a current ILr1 flowing through the first inductor 222 may charge the junction capacitor of the first switch 211, and discharge the junction capacitor of the second switch 212 and decrease the drain-source voltage VDS2 of the second switch 212 to zero voltage. Accordingly, the second switch 212 may be in a zero voltage state and/or a zero current state before turn-on, and may be turned on in a state of satisfying the soft switching condition.

According to an embodiment, the switching circuit 210 may apply a second gate driving signal of a high level to the second switch 212 with a slight deadtime after the drain-source voltage VDS2 of the second switch 212 is decreased to zero voltage, and turn on the second switch 212. In this case, the soft switching effect may be further enhanced.

As illustrated in the second transition duration 320, in a state in which the second switch 212 is turned on and thus a positive current is flowing (see the

IQ2 waveform diagram), and the drain-source voltage VDS1 of the first switch 211 is equal to the input voltage, the second switch 212 may be turned off when the switching circuit 210 changes the second gate driving signal of the second switch 212 from high to low. In this case, during the deadtime, the current ILr1 flowing through the first inductor 222 may charge the junction capacitor of the second switch 212, and discharge the junction capacitor of the first switch 211 and decrease the drain-source voltage VDS1 of the first switch 211 to zero voltage. Accordingly, the first switch 211 may be in a zero voltage state and/or a zero current state before turn-on, and may be turned on in a state of satisfying the soft switching condition.

According to an embodiment, the switching circuit 210 may apply a first gate driving signal of a high level to the first switch 211 with a slight deadtime after the drain-source voltage VDS1 of the first switch 211 is decreased to zero voltage, and turn on the first switch 211. In this case, the soft switching effect may be further enhanced.

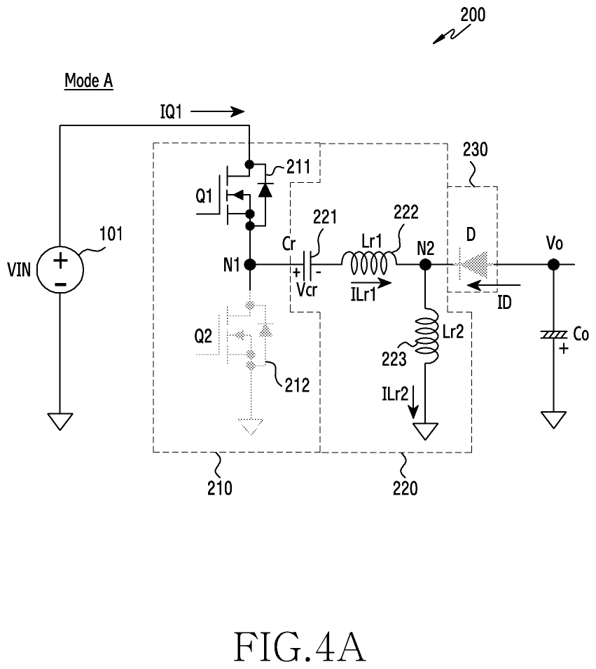

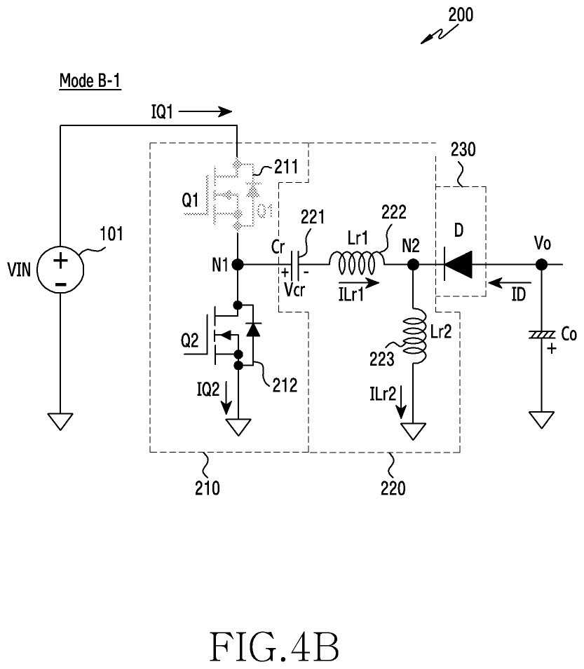

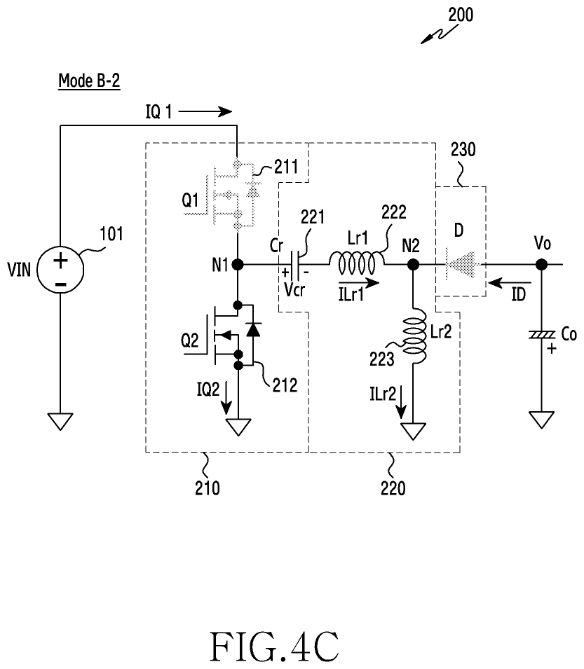

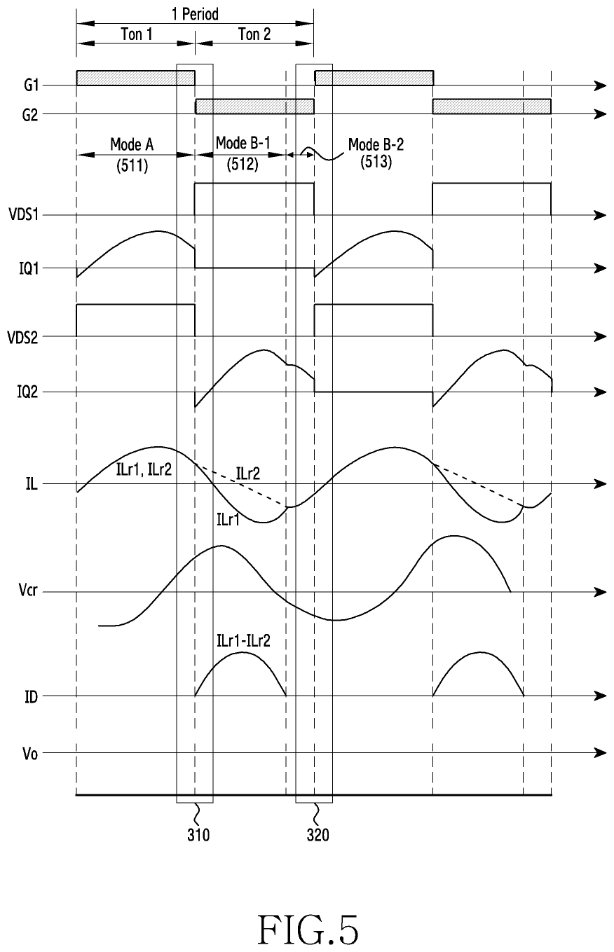

FIGS. 4A, 4B, and 4C are circuit diagrams illustrating example mode-specific operation of the power converter 200 according to various embodiments. FIG. 5 is a waveform diagram illustrating mode-specific operation of the power converter 200 according to various embodiments.

According to an embodiment, the power converter 200 may operate in one of three operation modes: first mode (Mode A), second mode (Mode B-1), and third mode (Mode B-2).

According to an embodiment, the power converter 200 may operate in one of the first mode (Mode A) of FIG. 4A, the second mode (Mode B-1) of FIG. 4B, and the third mode (Mode B-2) of FIG. 4C, depending on switching states (or on/off states) of the first switch 211, the second switch 212, and the third switch 230.

According to an embodiment, the power converter 200 may selectively turn off at least one of the first switch 211, the second switch 212, and the third switch 230 in each of the first mode (Mode A), the second mode (Mode B-1), and the third mode (Mode B-2), and change the mode. In each switching period (1 Period), the first mode (Mode A), the second mode (Mode B-1), and the third mode (Mode B-2) may be sequentially repeated.

According to an embodiment, the power converter 200 may include the resonant circuit 220. The resonant circuit 220 may include three resonant elements including one capacitor 221 and two inductors 222 and 223. The capacitor 221, the first inductor 222, and the second inductor 223 in the resonant circuit 220 may be connected in series with each other.

According to an embodiment, the resonant circuit 220 may be for multi-resonance according to the change of the operation mode of the power converter 200. In an embodiment, in at least some of the operation modes of the power converter 200, the resonance characteristics (e.g., resonance frequency, resonance period, and/or impedance) of the resonant circuit 220 may appear differently from each other.

According to an embodiment, the total inductance of the first inductor 222 and the second inductor 223 in the resonant circuit 220 used for multi-resonance operation may be reduced to half the inductance of an inductor used in a hard switching method. Accordingly, the overall size of the resonant circuit 220 may be reduced.

FIG. 4A shows a circuit operation state in the first mode (Mode A) of the power converter 200. According to an embodiment, as the first switch 211 among the first switch 211 and the second switch 212 arranged at the input side of the power converter 200 is turned on, the power converter 200 may operate in the first mode (Mode A) (or first state). In the first mode (Mode A), the third switch 230 arranged at the output side of the power converter 200 may be in a turn-off state.

FIG. 4B shows a circuit operation state in the second mode (Mode B-1) of the power converter 200. According to an embodiment, as the second switch 212 among the first switch 211 and the second switch 212 arranged at the input side of the power converter 200 is turned on, the operation mode of the power converter 200 may change from the first mode (Mode A) to the second mode (Mode B-1). In the second mode (Mode B-1), the third switch 230 arranged at the output side of the power converter 200 may be in a turn-on state.

FIG. 4C shows a circuit operation state in the third mode (Mode B-2) of the power converter 200. According to an embodiment, as the second switch 212 among the first switch 211 and the second switch 212 arranged at the input side of the power converter 200 is turned on and the third switch 230 arranged at the output side of the power converter 200 is switched from the turn-on state to a turn-off state, the operation mode of the power converter 200 may change from the second mode (Mode B-1) to the third mode (Mode B-2).

Referring to FIG. 4A, while the power converter 200 operates in the first mode (Mode A), only the first switch 211 among the first switch 211, the second switch 212, and the third switch 230 may be turned on.

In the first mode (Mode A), energy is not transferred to the load, but energy may be stored through the resonant circuit 220. In the first mode (Mode A), the resonant circuit 220 may be connected to the power source 101 through the turned-on first switch 211 of the input side. The input voltage from the power source 101 may be applied to the resonant circuit 220 through the turned-on first switch 211 and the first node N1. The rectifier diode, which is the third switch 230, may be turned off due to a reverse bias. As the third switch 230 is turned off, the resonant circuit 220 may be disconnected from the load.

In the first mode (Mode A), when the first node N1 of the resonant circuit 220 is connected to the power source 101 and the second node N2 is disconnected from the load, the first serial path (LLC resonant circuit) including the resonant capacitor 221, the first inductor 222, and the second inductor 223 may be driven. A series resonance of the resonant capacitor 221, the first inductor 222, and the second inductor 223 included in the first serial path (LLC resonant circuit) may occur. The resonance characteristics (e.g., resonance frequency, resonance period, and/or impedance) of the first mode (Mode A) may be determined based on the capacitance of the resonant capacitor 221 included in the first serial path and the total inductance (complex impedance) of the first inductor 222 and the second inductor 223. As the first serial path is driven, a resonant inductor current IL flowing in the first inductor 222 and the second inductor 223 may change due to the series resonance, and energy may be charged to the resonant capacitor 221 according to the change of the resonant inductor current.

Referring to FIG. 4B, while the power converter 200 operates in the second mode (Mode B-1), only the first switch 211 among the first switch 211, the second switch 212, and the third switch 230 may be turned off.

In the second mode (Mode B-1), the energy stored in the resonant circuit 220 during the first mode (Mode A) may be transferred to the load. In the second mode (Mode B-1), the first switch 211 among the first switch 211 and the second switch 212 of the input side may be turned off, and the third switch 230 of the output side may be turned on. In the second mode (Mode B-1), the resonant circuit 220 may be connected to the ground through the second switch 212 of the input side. The rectifier diode, which is the third switch 230, may be turned on due to a forward bias. The resonant circuit 220 may be connected to the load through the turned-on third switch 230.

In the second mode (Mode B-1), as the first node N1 of the resonant circuit 220 is connected to the ground, and the second node N2 is connected to the load, the second serial path circuit (LC resonant circuit) including the resonant capacitor 221 and the first inductor 222 may be driven. Among three resonant elements such as the resonant capacitor 221, the first inductor 222, and the second inductor 223 included in the resonant circuit 220, both terminals of the second inductor 223 may be connected to the output capacitor Co of the load side. The current ILr2 flowing in the second inductor 223 may be linearly decreased due to the inflow of a load current. In this state, series resonance may occur in the second serial path (LC resonant circuit) including the resonant capacitor 221 and the first inductor 222. The resonance characteristics (e.g., impedance, resonance period, or resonance frequency) of the second mode (Mode B-1) may be determined based on the capacitance of the resonant capacitor 221 included in the second serial path and the inductance of the first inductor 222. In a state of being connected to the load, energy charged to the resonant capacitor 221 may be discharged and supplied to the load by the series resonance occurring in the second serial path. The resonance period of the second serial path (LC resonant circuit) including the resonant capacitor 221 and the first inductor 222 may be shorter than the resonance period of the first serial path (LLC resonant circuit).

Referring to FIG. 4C, while the power converter 200 operates in the third mode (Mode B-2), only the second switch 212 among the first switch 211, the second switch 212, and the third switch 230 may be turned on.

In the third mode (Mode B-2), the rectifier diode, which is the third switch 230, may be turned off due to a reverse bias. As the first node N1 of the resonant circuit 220 is connected to the ground, and the second node N2 is disconnected from the load, the first serial path (LLC resonant circuit) including the resonant capacitor 221, the first inductor 222, and the second inductor 223 may be driven again. In the first serial path (LLC resonant circuit), series resonance may occur. The charging of energy through the resonant capacitor 221 may be resumed by the series resonance occurring in the first serial path.

According to an embodiment, the resonant circuit 220 may have different resonance frequencies in at least one of the first mode (Mode A), the second mode (Mode B-1), and the third mode (Mode B-2). The switching frequency of the switching circuit 210 may be controlled (or set) to have a higher value than the resonance frequencies of the resonant circuit 220, and achieve soft switching of each switch 211 or 212.

A first duration 511, a second duration 512, and a third duration 513 illustrated in FIG. 5 may be durations in which the power converter 200 operates in the first mode (Mode A) of FIG. 4A, the second mode (Mode B-1) of FIG. 4B, and the third mode (Mode B-2) of FIG. 4C, respectively.

In FIG. 5, one switching period (1 Period) of the power converter 200 may include a first switching duration (Ton1) and a second switching duration (Ton2). During the first switching duration (Ton1), the first switch 211 among a pair of switches 211 and 212 of the input side may be selectively turned on. During the second switching duration (Ton2), the second switch 212 among the pair of switches 211 and 212 of the input side may be selectively turned on. The second switching duration (Ton2) may be divided into the second duration 512 in which the third switch 230 of the output side is turned on, and the third duration 513 in which the third switch 230 of the output side is turned off. The first duration 511, the second duration 512, and the third duration 513 represent a duration in which the power converter 200 operates in the first mode (Mode A) of FIG. 4A, a duration in which the power converter 200 operates in the second mode (Mode B-1) of FIG. 4B, and a duration in which the power converter 200 operates in the third mode (Mode B-2) of FIG. 4C, respectively.

In FIG. 5, G1 is a waveform diagram of a first switching signal (or first gate driving signal) applied to a gate of the first switch 211. G2 is a waveform diagram of a second switching signal (or second gate driving signal) applied to a gate of the second switch 212. VDS1 is a waveform diagram of a drain-source voltage of the first switch 211. IQ1 is a waveform diagram of a first switch current flowing in the first switch 211. VDS2 is a waveform diagram of a drain-source voltage of the second switch 212. IQ2 is a waveform diagram of a second switch current flowing in the second switch 212. IL is a waveform diagram of a resonant inductor current, and represents a change of a current flowing in the first inductor 222 and/or the second inductor 223. Vcr is a waveform diagram of a resonant capacitor voltage, and represents a change of a charging voltage of the resonant capacitor 221. ID is a waveform diagram of a third switch current flowing in the third switch 230. Vo is a waveform diagram of the output voltage.

According to an embodiment, during one switching period, a switching state of each switch 211, 212, or 230 and/or the resonant inductor current IL flowing in the resonant circuit 220 may change according to a mode change of the power converter 200. Depending on the change of the resonant inductor current IL, magnetization (increase of charging current) and demagnetization (decrease of charging current) of the first inductor 222 and the second inductor 223 may occur. In conjunction with the change of the resonant inductor current IL, energy may be charged and discharged through the resonant capacitor 221.

According to an embodiment, a starting point of the first mode (Mode A) may be a point of time when only the first switch 211 among the first switch 211, the second switch 212, and the third switch 230 is selectively turned on. A starting point of the second mode (Mode B-1) may be a point of time when the second switch 212 and the third switch 230 among the first switch 211, the second switch 212, and the third switch 230 are selectively turned on. A starting point of the third mode (Mode B-2) may be a point of time when only the second switch 212 among the first switch 211, the second switch 212, and the third switch 230 is selectively turned on.

Referring to FIG. 4A and FIG. 5 together, during the first duration 511 in which the power converter 200 operates in the first mode, the first switch 211 is turned on as the first switching signal G1 switches from low to high, and the input voltage VIN may be applied to the first serial path (LLC series resonant circuit) including resonant capacitor 221—first inductor 222—second inductor 223 (Cr-Lr1-Lr2) through the first node N1. The rectifier diode used as the third switch 230 may be turned off due to a reverse bias. Due to the turn-off of the third switch 230, the resonant circuit 220 may be disconnected (or separated) from the load. The first switching signal G1 and the second switching signal G2 may be controlled to have the same switching frequency. The switching circuit 210 may directly adjust a turn-on time (corresponding to Ton1) (or duty ratio) of the first switch 211 or adjust the turn-on time (corresponding to Ton1) (or duty ratio) of the first switch 211 through the change of the switching frequency, and control the output voltage.

According to an embodiment, the turn-on time (corresponding to Ton1) of the first switch 211 may be controlled to be shorter than a resonance half-cycle of the first serial path (LLC series resonant circuit) including resonant capacitor 221-first inductor 222-second inductor 223 (Cr-Lr1-Lr2). Accordingly, the resonance frequency of the first serial path may have a lower value than the switching frequency. For example, when the capacitance Cr of the resonant capacitor 221 is 60 nF, the inductance Lr1 of the first inductor 222 is 300 nH, and the inductance Lr2 of the second inductor 223 is 200 nH, the resonance half-cycle may be 544 ns, and the resonance frequency may be 919 kHz that is lower than a switching frequency of 1 MHz.

During the first duration 511 in which the power converter 200 operates in the first mode (Mode A), energy may be stored in the resonant capacitor 221 through the first serial path (LLC series resonant circuit), and the charging voltage Vcr may be built-up in the resonant capacitor 221. During the first duration 511, the resonant inductor current IL as illustrated in the first duration 511 of FIG. 5 may flow through the first inductor 222 and the second inductor 223 included in the first serial path (LLC series resonant circuit). Since the first inductor 222 and the second inductor 223 are connected in series with each other, the resonant inductor currents (IL=ILr1=ILr2) flowing in the first inductor 222 and the second inductor 223 may be the same. The resonant inductor current IL may have a negative value (negative current flowing in reverse direction) at the beginning of the first duration 511. The resonant inductor current IL may change to a positive value (positive current flowing in forward direction) over time, and the magnitude (amplitude) of the resonant inductor current IL may increase to a maximum value and then decrease. In conjunction with this change of the resonant inductor current IL, energy may be charged to the resonant capacitor 221, and the charging voltage of the resonant capacitor 221 may increase.

Referring to FIG. 4B and FIG. 5 together, during the second duration 512 in which the power converter 200 operates in the second mode (Mode B-1), as the second switching signal G2 is switched from low to high, the second switch 212 may be switched from a turn-off state to a turn-on state, and both terminals of the second inductor 223 may be connected to the output capacitor (or load). A series resonance of the second serial path (LC series resonant circuit) including the resonant capacitor 221 and the first inductor 222 (Cr-Lr1) may occur.

The resonance period of the second serial path (LC series resonant circuit) driven in the second mode (Mode B-1) may be shorter than the resonance period of the first serial path (LLC series resonant circuit) driven in the first mode (Mode A). Before the second switch 212 is turned off, a resonance half-cycle of the second serial path (LC series resonant circuit) including resonant capacitor 221-first inductor 222 (Cr-Lr1) may be terminated. During the second duration 512, a current (ID) flowing in the rectifier diode used as the third switch 230 may be determined by a difference between the first current ILr1 flowing in the first inductor 222 and the second current ILr2 flowing in the second inductor 223. During the second duration 512, the rectifier diode may be turned on as the forward bias is applied.

During the second duration 512 in which the power converter 200 operates in the second mode (Mode B-1), the resonant circuit 220 may transfer energy stored in the resonant capacitor 221 during the first duration 511, to the load (or output capacitor Co) through the second serial path (LC series resonant circuit) and the second node N2. The charging voltage Vcr of the resonant capacitor 221 may be reduced to a zero voltage level.

During the second duration 512, the first inductor current ILr1 as illustrated in the second duration 512 of FIG. 5 may flow through the first inductor 222 that operates as the resonant element of the second serial path (LC series resonant circuit). During the second duration 512, the second inductor current ILr2 flowing in the second inductor 223 connected to both terminals of the output capacitor Co may decrease linearly. The first inductor current ILr1 may have a positive value (positive current flowing in forward direction) at the beginning of the second duration 512. The first inductor current ILr1 changes to a negative value (negative current flowing in reverse direction) over time, and the magnitude (amplitude) of the first inductor current ILr1 may decrease to a minimum value and then begin to increase. In conjunction with this change of the first inductor current ILr1, energy may be discharged from the resonant capacitor 221, and the charging voltage of the resonant capacitor 221 may decrease.

Referring to FIG. 4C and FIG. 5 together, during the third duration 513 in which the power converter 200 operates in the third mode (Mode B-2), the turn-on of the second switch 212 may be maintained, and the rectifier diode used as the third switch 230 may be turned off again due to the reverse bias. As the third switch 230 is turned off, the first serial path (LLC resonant circuit) including resonant capacitor 221—first inductor 222—second inductor 223 (Cr-Lr1-Lr2) may be driven again.

During the third duration 513, the resonant inductor current IL as illustrated in the third duration 513 of FIG. 5 may flow through the first inductor 222 and the second inductor 223 included in the first serial path (LLC series resonant circuit). The resonant inductor currents (IL=ILr1=ILr2) flowing in the first inductor 222 and the second inductor 223 connected in series with each other may be the same. During the third duration 513, the resonant inductor current IL may be maintained as a negative value (negative current flowing in reverse direction), and the magnitude (amplitude) of the resonant inductor current IL may gradually decrease.

According to an embodiment, the first switch 211, the second switch 212, and the third switch 230 included in the power converter 200 may all perform a soft switching operation of transitioning in a zero voltage and/or zero current state.

Referring to FIG. 5, during the first transition duration 310, the second switch current IQ2 flowing in the second switch 212 may be a zero current (or negative current). For example, the first transition duration 310 may be a duration in which the power converter 200 is switched from the first mode (Mode A) to the second mode (Mode B-1).

During the first transition duration 310, the turned-off second switch 212 may be in a zero current and/or zero voltage state before being turned on due to the resonant inductor current (IL=ILr1=ILr2) flowing in the first serial path within the resonant circuit 220. Accordingly, the turn-on of the second switch 212 may be performed in a state of satisfying the soft switching condition.

During the first transition duration 310, the third switch current (ID) (e.g., diode current) flowing in the third switch 230 (e.g., rectifier diode) may be a zero current. Since the third switch 230 is turned on only during the second duration 512 of one switching period (1 Period), the third switch 230 may relatively easily maintain the zero current and/or zero voltage state before being turned on. Accordingly, the turn-on of the third switch 230 may be performed in a state of satisfying the soft switching condition.

During the second transition duration 320, the first switch current IQ1 flowing in the first switch 211 may be a zero current (or negative current). For example, the second transition duration 320 may be a duration in which the power converter 200 is switched from the third mode (Mode B-2) to the first mode (Mode A).

During the second transition duration 320, the first switch 211, which is turned off by the resonant inductor current IL or ILr1 flowing in the second serial path within the resonant circuit 220, may be in a zero current and/or zero voltage state before being turned on. Accordingly, the turn-on of the first switch 211 may be performed in a state of satisfying the soft switching condition.

According to an embodiment, the level of the output voltage transferred to the output node Vo may be determined depending on the length of the first duration 511 that is a duration time of the first mode (Mode A).

In an example, the switching circuit 210 may control the output voltage by a PFM operation of maintaining a duty cycle of 50% and varying the switching frequency. The switching frequency may be controlled to a value within a range higher than the resonance frequency for the sake of the zero voltage switching effect. As the value of the switching frequency increases, the time of energy storage through the resonant circuit 220 may decrease, and thus the output voltage may decrease.

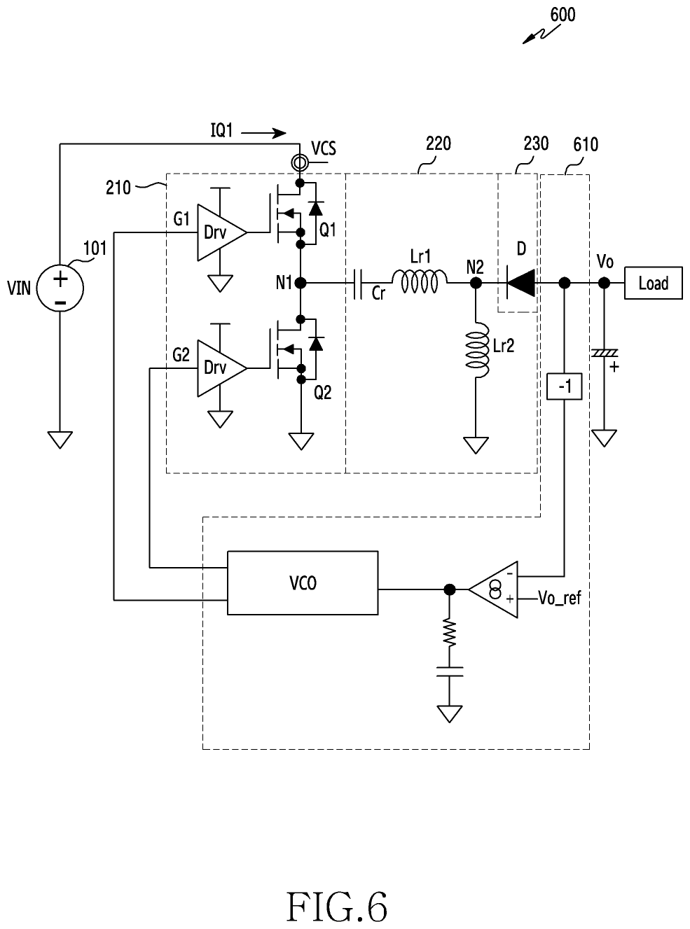

In an example, the switching circuit 210 may control the output voltage by a PWM operation of fixing the switching frequency and varying the turn-on time (corresponding to Ton1) of the first switch 211 (or duty ratio of first switching signal G1). The turn-on time (corresponding to Ton1) of the first switch 211 may be controlled to a value smaller than the resonance half-cycle for the sake of the zero-voltage switching effect. As the turn-on time (corresponding to Ton1) of the first switch 211 decreases, the time of energy storage through the resonant circuit 220 may decrease, and thus the output voltage may decrease. FIGS. 6, 7, and 8 are circuit diagrams illustrating examples 600, 700, and 800 of modifications of the power converter 200 according to various embodiments.

According to an embodiment, the power converter 200 of FIG. 2 may be implemented by omitting some components or further including components not shown.

Referring to FIG. 6, the power converter 200 may include the switching circuit 210, the resonant circuit 220, and the third switch 230. The third switch 230 may be the rectifier diode of the output side. The power converter 200 may further include a PFM control circuit 610. The PFM control circuit 610 may perform a PFM operation of varying the switching frequency of the switching circuit 210 using a voltage controlled oscillator VCO and supply a constant level of output voltage desired by the load through the output node Vo.

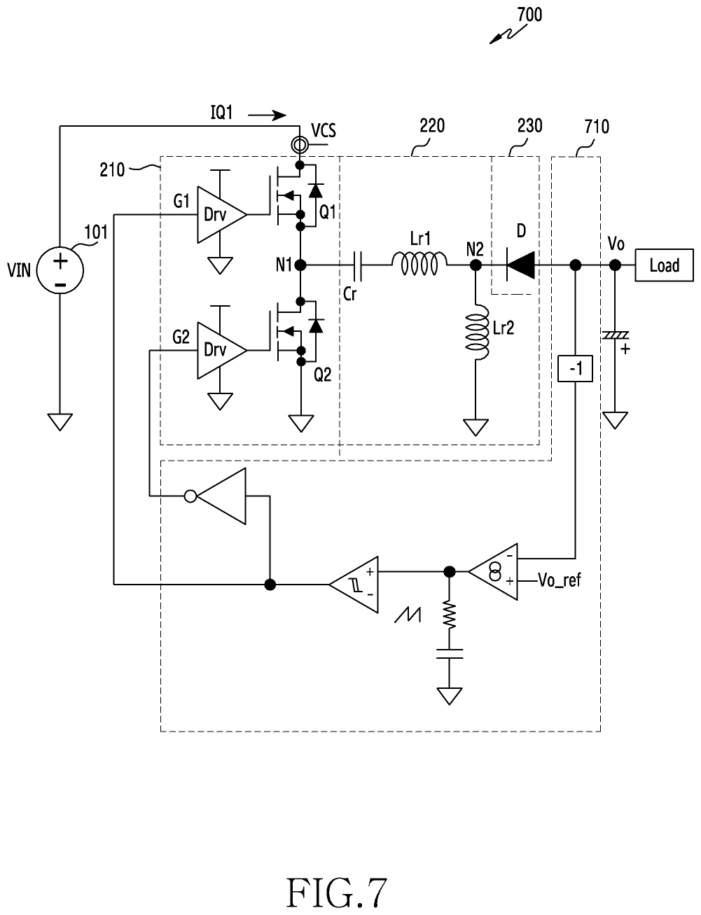

Referring to FIG. 7, the power converter 200 may further include a PWM control circuit 710. The PWM control circuit 710 may vary a duty ratio (or duty cycle) of the first switching signal and the second switching signal and supply a constant level of output voltage desired by the load through the output node Vo.

Referring to FIG. 8, the rectifier diode within the third switch 230 of the power converter 200 may be replaced with a MOSFET 231. The MOSFET 231 used as the third switch 230 may act as a synchronous rectifier. The MOSFET 231 used as the third switch 230 may be turned on and off in response to a third switching signal from the switching circuit 210. The third switching signal may be a third gate driving signal applied to a gate of the MOSFET 231.

The switching circuit 210 may monitor a current passing through the second node N2, for example, a current flowing from a source to a drain of the MOSFET 231 and, only when the current has a positive value, the switching circuit 210 may apply a third switching signal of a high level and control the MOSFET 231 to be turned on.

FIG. 9 is a block diagram illustrating an example configuration of an electronic device 1001 including the power converter 200 according to various embodiments.

Referring to FIG. 9, the electronic device 1001 of an embodiment may include a display 910, a display driver IC 920, and a display power management circuit (PMIC) 930. In an example, the display 910 may include an organic light emitting display that requires a negative driving voltage in addition to a positive driving voltage. In an example, the display 910 may include a flexible display.

According to an embodiment, the electronic device 1001 may be implemented by omitting some components or further including components not shown. For example, the electronic device 1001 corresponds to an electronic device 1001 of FIG. 10, and may further include a processor 1020 and/or a battery 1089 illustrated in FIG. 10.

In an embodiment, the display 910, the display driver IC 920, and/or the display PMIC 930 may be electrically connected to each other.

According to an embodiment, the display driver IC 920 is for driving the display 910. The display driver IC 920 may convert data transmitted from a processor (e.g., processor 1020 of FIG. 10) into a form that may be transmitted to the display 910, and may transmit the converted data (or display data) to the display 910 and present visual information to a user through the display 910. In an example, the converted data may be transmitted in the unit of pixels (PX).

According to an embodiment, the display PMIC 930 may include the power converter 200, and may provide a driving voltage necessary to drive the display 910 and/or the display driver IC 920 using the power converter 200. The display PMIC 930 may convert an input voltage from the power source 101 (e.g., battery 1089 or alternating current adapter of FIG. 10) into a negative output voltage using the power converter 200, and supply the negative output voltage to the display driver IC 920. The display driver IC 920 may provide a driving voltage(s) necessary to drive the display 910 using the negative output voltage. Since the construction and operations of the power converter 200 within the display PMIC 930 have already been described with reference to FIGS. 2, 3, 4A, 4B, 5, 6, 7, and 8, a detailed description thereof will be omitted.

FIG. 10 is a block diagram illustrating an example electronic device 1001 in a network environment 1000 according to various embodiments.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, and/or an antenna module 1097. In various embodiments, at least one of the components (e.g., the connecting terminal 1078) may be omitted from the electronic device 1001, or one or more other components may be added in the electronic device 1001. In various embodiments, some of the components (e.g., the sensor module 1076, the camera module 1080, or the antenna module 1097) may be implemented as a single component (e.g., the display module 1060).

The processor 1020 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, a HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the mmWave band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099).

According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element including a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002, 1004, or 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In an embodiment, the external electronic device 1004 may include an internet-of-things (IoT) device. The server 1008 may be an intelligent server using machine learning and/or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

A power converter (e.g., power converter 200 of FIG. 2) according to an example embodiment includes a power converter configured to convert an input voltage from a power source (e.g., power source 101 of FIG. 2) into a negative output voltage, and may include: a switching circuit (e.g., switching circuit 210 of FIG. 2), a resonant circuit (e.g., resonant circuit 220 of FIG. 2), and a third switch (e.g., third switch 230 of FIG. 2 or MOSFET 231 of FIG. 8). The switching circuit (e.g., switching circuit 210 of FIG. 2) may be connected in series between the power source and the ground, and may include a first switch (e.g., first switch 211 of FIG. 2) and a second switch (e.g., first switch 212 of FIG. 2) configured to be alternately turned on. The resonant circuit (e.g., resonant circuit 220 of FIG. 2) may be connected to the switching circuit (e.g., switching circuit 210 of FIG. 2) through a first node between the first switch (e.g., first switch 211 of FIG. 2) and the second switch (e.g., first switch 212 of FIG. 2). The resonant circuit (e.g., resonant circuit 220 of FIG. 2) may include a resonant capacitor (e.g., resonant capacitor 221 of FIG. 2), a first inductor (e.g., first inductor 222 of FIG. 2), and a second inductor (e.g., second inductor 223 of FIG. 2) connected in series with each other. The third switch (e.g., third switch 230 of FIG. 2 or MOSFET 231 of FIG. 8) may be connected to the resonant circuit (e.g., resonant circuit 220 of FIG. 2) through a second node between the first inductor (e.g., first inductor 222 of FIG. 2) and the second inductor (e.g., second inductor 223 of FIG. 2). The third switch (e.g., third switch 230 of FIG. 2 or MOSFET 231 of FIG. 8) may be configured to connect or disconnect between the resonant circuit (e.g., resonant circuit 220 of FIG. 2) and a load. An operating mode of the power converter (e.g., power converter 200 of FIG. 2) may include a first mode, a second mode, and a third mode. The first mode may include a mode of turning on the first switch (e.g., first switch 211 of FIG. 2) connected to the power source (e.g., power source 101 of FIG. 2), and turning off the third switch (e.g., third switch 230 of FIG. 2 or MOSFET 231 of FIG. 8). The second mode may include a mode of turning on the second switch (e.g., second switch 212 of FIG. 2) connected to the ground, and turning on the third switch (e.g., third switch 230 of FIG. 2 or MOSFET 231 of FIG. 8). The third mode may include a mode of turning on the second switch (e.g., second switch 212 of FIG. 2) connected to the ground, and turning off the third switch (e.g., third switch 230 of FIG. 2 or MOSFET 231 of FIG. 8).

According to an example embodiment, the first mode may include a mode for storing energy through the resonant circuit. The second mode may include a mode for supplying the energy stored in the resonant circuit to the load. The third mode may include a mode for supporting soft switching of at least one of the first switch, the second switch, and the third switch.

According to an example embodiment, the switching circuit may provide a first switching signal for the first switch and a second switching signal for the second switch by a pulse frequency modulation (PFM) method or a pulse width modulation (PWM) method. The switching circuit may be configured to regulate the negative output voltage to a specified level using the first switching signal and the second switching signal.

According to an example embodiment, the switching frequency of the first switching signal and the switching frequency of the second switching signal may have higher values than a resonance frequency of the resonant circuit.

According to an example embodiment, the first switching signal and the second switching signal may be configured to be alternately applied with a specified delay time.

According to an example embodiment, the input voltage may include a battery voltage, and the switching circuit may be configured to vary a switching frequency of the first switching signal and a switching frequency of the second switching signal to regulate the negative output voltage regardless of a battery charge state or a load state.

According to an example embodiment, while the power converter operates in the first mode, the power converter may be configured to store energy in the resonant capacitor through a first serial path within the resonant circuit including the resonant capacitor, the first inductor, and the second inductor. While the power converter operates in the second mode, the power converter may be configured to supply the energy stored in the resonant capacitor to the load through a second serial path within the resonant circuit including the resonant capacitor and the first inductor. While the power converter operates in the third mode, the power converter may be configured to reduce a voltage of the first node to zero voltage by a current flowing in the first serial path within the resonant circuit and allow the turned-off first switch to satisfy a soft switching condition before turn-on.

According to an example embodiment, the resonant circuit may have different resonance frequencies in at least one of the first mode, the second mode, and the third mode. A switching frequency of the switching circuit may have a higher value than the resonance frequencies.

According to an example embodiment, the third switch connected to the second node may be configured to be turned off, based on a difference between a first current flowing in the first inductor and a second current flowing in the second inductor.

According to an example embodiment, the third switch may include a rectifier diode and may be configured to be turned off based on a reverse bias being applied to the rectifier diode.

According to an example embodiment, the third switch may include a metal oxide semiconductor field effect transistor (MOSFET) and may be configured to be turned off in response to a third switching signal from the switching circuit.

An electronic device (e.g., electronic device 1001 of FIG. 9) according to an example embodiment may include: an organic light emitting display (e.g., display 910 of FIG. 9), a display driver IC (DDI) (e.g., display driver IC 920 of FIG. 9) configured to drive the organic light emitting display, and a display power management IC (PMIC) (e.g., display PMIC 930 of FIG. 9) including a power converter (e.g., power converter 200 of FIG. 2 or 9) configured to convert an input voltage from a power source into a negative output voltage, and configured to provide a driving voltage required to drive the display driver IC using the power converter. The power converter (e.g., power converter 200 of FIG. 2 or 9) may include: a switching circuit (e.g., switching circuit 210 of FIG. 2), a resonant circuit (e.g., resonant circuit 220 of FIG. 2), and a third switch (e.g., third switch 230 of FIG. 2 or MOSFET 231 of FIG. 8). The switching circuit (e.g., switching circuit 210 of FIG. 2) may be connected in series between the power source and the ground, and may include a first switch (e.g., first switch 211 of FIG. 2) and a second switch (e.g., first switch 212 of FIG. 2) configured to be alternately turned on. The resonant circuit (e.g., resonant circuit 220 of FIG. 2) may be connected to the switching circuit (e.g., switching circuit 210 of FIG. 2) through a first node between the first switch (e.g., first switch 211 of FIG. 2) and the second switch (e.g., first switch 212 of FIG. 2). The resonant circuit (e.g., resonant circuit 220 of FIG. 2) may include a resonant capacitor (e.g., resonant capacitor 221 of FIG. 2), a first inductor (e.g., first inductor 222 of FIG. 2), and a second inductor (e.g., second inductor 223 of FIG. 2) connected in series with each other. The third switch (e.g., third switch 230 of FIG. 2 or MOSFET 231 of FIG. 8) may be connected to the resonant circuit (e.g., resonant circuit 220 of FIG. 2) through a second node between the first inductor (e.g., first inductor 222 of FIG. 2) and the second inductor (e.g., second inductor 223 of FIG. 2). The third switch (e.g., third switch 230 of FIG. 2 or MOSFET 231 of FIG. 8) may be configured to connect or disconnect between the resonant circuit (e.g., resonant circuit 220 of FIG. 2) and a load. An operating mode of the power converter (e.g., power converter 200 of FIG. 2) may include a first mode, a second mode, and a third mode. The first mode may include a mode of turning on the first switch (e.g., first switch 211 of FIG. 2) connected to the power source (e.g., power source 101 of FIG. 2), and turning off the third switch (e.g., third switch 230 of FIG. 2 or MOSFET 231 of FIG. 8). The second mode may include a mode of turning on the second switch (e.g., second switch 212 of FIG. 2) connected to the ground, and turning on the third switch (e.g., third switch 230 of FIG. 2 or MOSFET 231 of FIG. 8). The third mode may include a mode of turning on the second switch (e.g., second switch 212 of FIG. 2) connected to the ground, and turning off the third switch (e.g., third switch 230 of FIG. 2 or MOSFET 231 of FIG. 8).

According to an example embodiment, the first mode may include a mode configured to store energy through the resonant circuit. The second mode may include a mode configured to supply the energy stored in the resonant circuit to the load. The third mode may include a mode configured to support soft switching of at least one of the first switch, the second switch, and the third switch.

According to an example embodiment, the switching circuit may be configured to provide a first switching signal for the first switch and a second switching signal for the second switch by a pulse frequency modulation (PFM) method or a pulse width modulation (PWM) method. The switching circuit may be configured to regulate the negative output voltage to a specified level using the first switching signal and the second switching signal.

According to an example embodiment, the switching frequency of the first switching signal and the switching frequency of the second switching signal may have higher values than a resonance frequency of the resonant circuit.

According to an example embodiment, the first switching signal and the second switching signal may be configured to be alternately applied with a specified delay time.

According to an example embodiment, the input voltage may be a battery voltage, and the switching circuit may be configured to vary a switching frequency of the first switching signal and a switching frequency of the second switching signal to regulate the negative output voltage regardless of a battery charge state or a load state.

According to an example embodiment, while the power converter operates in the first mode, the power converter may be configured to store energy in the resonant capacitor through a first serial path within the resonant circuit including the resonant capacitor, the first inductor, and the second inductor. While the power converter operates in the second mode, the power converter may be configured to supply the energy stored in the resonant capacitor to the load through a second serial path within the resonant circuit including the resonant capacitor and the first inductor. While the power converter operates in the third mode, the power converter may be configured to reduce a voltage of the first node to zero voltage by a current flowing in the first serial path within the resonant circuit and allow the turned-off first switch to satisfy a soft switching condition before turn-on.

According to an example embodiment, the resonant circuit may have different resonance frequencies in at least one of the first mode, the second mode, and the third mode. A switching frequency of the switching circuit may have a higher value than the resonance frequencies.

According to an example embodiment, the third switch connected to the second node may be configured to be turned off, based on a difference between a first current flowing in the first inductor and a second current flowing in the second inductor.

According to an example embodiment, the third switch may include a rectifier diode and may be configured to be turned off based on a reverse bias being applied to the rectifier diode.

According to an example embodiment, the third switch may include a metal oxide semiconductor field effect transistor (MOSFET) and may be configured to be turned off in response to a third switching signal from the switching circuit.

According to various embodiments of the disclosure, all the switches included in the power converter may perform a soft switching operation of transitioning in a zero voltage and/or zero current state, and thus may reduce a switching loss and improve a power conversion efficiency.

In addition, the total inductance of inductors used in the resonant circuit may be reduced to half compared to a hard switching method, and thus the overall size of the resonant circuit may be reduced.

The effects obtainable from the disclosure are not limited to the effects mentioned above, and other effects not mentioned may be clearly understood by a person having ordinary skill in the art to which the disclosure belongs from the above description.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A power converter configured to convert an input voltage from a power source into a negative output voltage, comprising:
a switching circuit comprising a first switch and a second switch connected in series between the power source and the ground and configured to be alternately turned on;
a resonant circuit connected to the switching circuit through a first node between the first switch and the second switch, and comprising a resonant capacitor, a first inductor, and a second inductor connected in series with each other; and
a third switch connected to the resonant circuit through a second node between the first inductor and the second inductor, and configured to connect or disconnect between the resonant circuit and a load,
wherein an operating mode of the power converter comprises:
a first mode configured to turn on the first switch connected to the power source, and to turn off the third switch;
a second mode configured to turn on the second switch connected to the ground, and to turn on the third switch; and
a third mode configured to turn on the second switch connected to the ground, and to turn off the third switch.

2. The power converter of claim 1, wherein the first mode comprises a mode configured to store energy through the resonant circuit,
the second mode comprises a mode configured to supply the energy stored in the resonant circuit to the load, and
the third mode comprises a mode configured to support soft switching of at least one of the first switch, the second switch, and the third switch.

3. The power converter of claim 1, wherein the switching circuit is configured to:
provide a first switching signal for the first switch and a second switching signal for the second switch by a pulse frequency modulation (PFM) method or a pulse width modulation (PWM) method; and
regulate the negative output voltage to a specified level using the first switching signal and the second switching signal.

4. The power converter of claim 3, wherein a switching frequency of the first switching signal and a switching frequency of the second switching signal have higher values than a resonance frequency of the resonant circuit.

5. The power converter of claim 3, wherein the first switching signal and the second switching signal are configured to be alternately applied with a specified delay time.

6. The power converter of claim 3, wherein the input voltage includes a battery voltage, and
the switching circuit is configured to vary a switching frequency of the first switching signal and a switching frequency of the second switching signal to regulate the negative output voltage regardless of a battery charge state or a load state.

7. The power converter of claim 1, wherein the power converter is configured to:
while the power converter operates in the first mode, store energy in the resonant capacitor through a first serial path within the resonant circuit comprising the resonant capacitor, the first inductor, and the second inductor;
while the power converter operates in the second mode, supply the energy stored in the resonant capacitor to the load through a second serial path within the resonant circuit comprising the resonant capacitor and the first inductor; and
while the power converter operates in the third mode, reduce a voltage of the first node to zero voltage by a current flowing in the first serial path within the resonant circuit and allow the turned-off first switch to satisfy a soft switching condition before turn-on.

8. The power converter of claim 7, wherein the resonant circuit has different resonance frequencies in at least one of the first mode, the second mode, and the third mode, and
a switching frequency of the switching circuit has a higher value than the resonance frequencies.

9. The power converter of claim 1, wherein the third switch connected to the second node is configured to be turned off, based on a difference between a first current flowing in the first inductor and a second current flowing in the second inductor.

10. The power converter of claim 9, wherein the third switch comprises a rectifier diode and is configured to be turned off based on a reverse bias being applied to the rectifier diode, or
the third switch comprises a metal oxide semiconductor field effect transistor (MOSFET) and is configured to be turned off in response to a third switching signal from the switching circuit.

11. An electronic device comprising:
an organic light emitting display;
a display driver IC (DDI) configured to drive the organic light emitting display; and
a display power management IC (PMIC) comprising a power converter configured to convert an input voltage from a power source into a negative output voltage, and configured to provide a driving voltage required to drive the display driver IC using the power converter,
wherein the power converter comprises:
a switching circuit comprising a first switch and a second switch connected in series between the power source and the ground and configured to be alternately turned on;
a resonant circuit connected to the switching circuit through a first node between the first switch and the second switch, and comprising a resonant capacitor, a first inductor, and a second inductor connected in series with each other; and
a third switch connected to the resonant circuit through a second node between the first inductor and the second inductor, and configured to connect between the resonant circuit and a load,
wherein an operating mode of the power converter comprises:
a first mode configured to turn on the first switch connected to the power source, and to turn off the third switch;
a second mode configured to turn on the second switch connected to the ground, and to turn on the third switch; and
a third mode configured to turn on the second switch connected to the ground, and to turn off the third switch.

12. The electronic device of claim 11, wherein the first mode comprises a mode configured to store energy through the resonant circuit,
the second mode comprises a mode configured to supply the energy stored in the resonant circuit to the load, and
the third mode comprises a mode configured to support soft switching of at least one of the first switch, the second switch, and the third switch.

13. The electronic device of claim 11, wherein the switching circuit is configured to:
provide a first switching signal for the first switch and a second switching signal for the second switch by a pulse frequency modulation (PFM) method or a pulse width modulation (PWM) method; and
regulate the negative output voltage to a specified level using the first switching signal and the second switching signal.

14. The electronic device of claim 13, wherein a switching frequency of the first switching signal and a switching frequency of the second switching signal have higher values than a resonance frequency of the resonant circuit.

15. The electronic device of claim 13, wherein the first switching signal and the second switching signal are configured to be alternately applied with a specified delay time.

16. The electronic device of claim 13, wherein the input voltage includes a battery voltage, and
the switching circuit is configured to vary a switching frequency of the first switching signal and a switching frequency of the second switching signal to regulate the negative output voltage regardless of a battery charge state or a load state.

17. The electronic device of claim 11, wherein the power converter is configured to:
while the power converter operates in the first mode, store energy in the resonant capacitor through a first serial path within the resonant circuit comprising the resonant capacitor, the first inductor, and the second inductor;
while the power converter operates in the second mode, supply the energy stored in the resonant capacitor to the load through a second serial path within the resonant circuit comprising the resonant capacitor and the first inductor; and
while the power converter operates in the third mode, reduce a voltage of the first node to zero voltage by a current flowing in the first serial path within the resonant circuit and allow the turned-off first switch to satisfy a soft switching condition before turn-on.

18. The electronic device of claim 17, wherein the resonant circuit has different resonance frequencies in at least one of the first mode, the second mode, and the third mode, and
a switching frequency of the switching circuit has a higher value than the resonance frequencies.

19. The electronic device of claim 11, wherein the third switch connected to the second node is configured to be turned off, based on a difference between a first current flowing in the first inductor and a second current flowing in the second inductor.

20. The electronic device of claim 19, wherein the third switch comprises a rectifier diode and is configured to be turned off based on a reverse bias being applied to the rectifier diode, or
the third switch comprises a metal oxide semiconductor field effect transistor (MOSFET) and is configured to be turned off in response to a third switching signal from the switching circuit.
